(19) United States
(12) Patent Application Publication
(10) Pub. No.: US 2006/0007357 A1
(43) Pub. Date: Jan. 12, 2006

(54) Apparatus and method for controlling fan of refrigerator with television/radio module

(75) Inventor: Ik-Kyu Lee, Changwon City (KR)

Correspondence Address: FLESHNER & KIM, LLP, P.O. BOX 221200, CHANTILLY, VA, 20153, US

(73) Assignee: LG Electronics Inc.

(21) Appl. No.: 11/154,672

(22) Filed: Jun. 17, 2005

(30) Foreign Application Priority Data
Jun. 21, 2004 (KR) 2004-0046286

(51) Int. Cl. H04N 11/00

(52) U.S. Cl. 348/552; 348/460

(57) ABSTRACT

The present invention relates to an apparatus and method for controlling a fan of a refrigerator with a television/radio module, wherein an operation of the fan is controlled according to an operation of the television/radio module. The present invention is characterized in that when the television or radio is operated, electric power is controlled to be automatically supplied to the heat radiation fan such that heat generated due to the television or radio operation can be radiated. Further, the heat radiation fan is also controlled to be automatically turned off when the television and radio operation is terminated. Therefore, the unnecessary operation of the heat radiation fan is prevented, and consequently, reduction in electric power consumption and efficient control can be made.

### BACKGROUND OF THE INVENTION

1. Field of Invention

The present invention relates to a refrigerator with a television/radio module, and more particularly, to an apparatus and method for controlling a fan of a refrigerator with a television/radio module, wherein the fan operation is controlled according to the operation of the television/radio module.

2. Description of the Prior Art

Refrigerators are used to safely and freshly store foods. As shown in FIG. 1, a refrigerator generally comprises a storage space for storing goods therein, which in turn is divided into a freezing chamber 80a for freezing and storing goods and a refrigerating chamber 80b for refrigerating and storing goods. Further, each compartment in the storage space of the refrigerator is provided with a cold air outlet through which cold air is discharged in the compartment.

Recently, high functioning in which a function of the product itself is improved as well as multi-functioning in which a variety of functions are combined and integrated into a single product have been proposed in the field of electrical appliances.

In addition to an inherent refrigerating or freezing function of a refrigerator, it may also be mounted with a wireless communication module that allows a user to send or receive E-mails or to enjoy Internet surfing or with a television or radio module that allows a user to watch the television broadcast or to listen to the radio.

As stated above, in a case where a television module is mounted to a refrigerator, heat is generated from the television module. If the heat is transferred to the interior of the storage space of the refrigerator, refrigeration efficiency may be reduced and television image quality may also be deteriorated due to noise. To solve such heat generation, a heat radiation fan for radiating heat generated due to the operation of the television or radio module is installed to a rear panel of the television or radio module.

However, when electric power is applied to a television/radio module, the related art heat radiation fan is continuously operated even though a user does not watch television or listen to the radio. In such a case, there is a problem in that the electric power is unnecessarily wasted and noise is produced due to the operation of the fan.

### SUMMARY OF THE INVENTION

Accordingly, the present invention is conceived to solve the aforementioned problem in the prior art. An object of the present invention is to provide an apparatus and method for controlling a fan of a refrigerator with a television/radio module, wherein the operation of the fan can be controlled according to the operation of the television/radio module to reduce the consumption of electric power.

According to an aspect of the present invention for achieving the objects, there is provided a method for controlling a fan of a refrigerator with a television/radio module, which comprises a monitoring step of monitoring an operation of a television power button for selecting a television function and an operation of a radio power button for selecting a radio function in a state where electric power is supplied to the television/radio module; and a fan control step of controlling the fan in such a manner that electric power is supplied to a heat radiation fan for radiating heat generated due to the television and radio operation when any power button is turned on in the monitoring step, whereas the electric power supplied to the fan is cut off when the operating power button is turned off.

Preferably, in the fan control step, the supply of electric power to the heat radiation fan is made when a predetermined period of time has been elapsed after the television or radio power button is turned on.

More preferably, in the fan control step, the supply of electric power to the heat radiation fan is cut off when a predetermined period of time has been elapsed after the television or radio power button is turned off.

According to another aspect of the present invention, there is provided an apparatus for controlling a fan of a refrigerator with a television/radio module, which comprises a television power button for selecting a television function; a radio power button for selecting a radio function; a power switch for enabling electric power to be supplied to the television/radio module; a heat radiation fan installed at a rear surface of a television panel for radiating heat generated due to a television and radio operation; a fan control switch for switching on or off electric power supplied to the heat radiation fan; and a microcomputer for monitoring an operating state of the power buttons and controlling the fan control switch in such a manner that the fan control switch is turned on when the television or radio power button is turned on, whereas the fan control switch is turned off when the operating power button is turned off, in a state where the television module power switch is turned on.

### BRIEF DESCRIPTION OF THE DRAWINGS

The above and other objects, features and advantages of the present invention will become apparent from the following description of a preferred embodiment given in conjunction with the accompanying drawings, in which:

FIG. 1 is a perspective view of a general refrigerator;

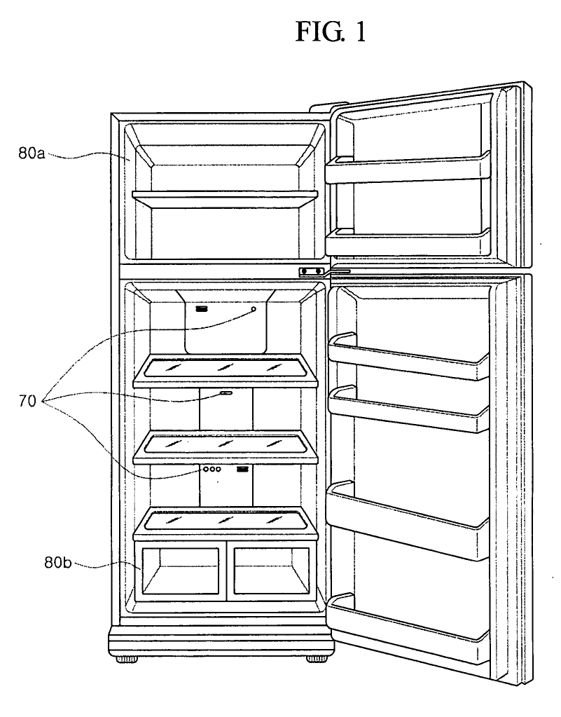

FIG. 2 is a perspective view of a refrigerator with a television/radio module according to an embodiment of the present invention;

FIG. 3 is a circuit diagram for controlling a fan of a refrigerator with a television/radio module according to the present invention;

FIG. 4 is a diagram illustrating operating states of various kinds of power buttons in the refrigerator with a television/radio module according to the present invention; and

FIG. 5 is a flowchart illustrating a fan control operation performed automatically according to an operation of the television/radio module in the refrigerator of the present invention.

### DETAILED DESCRIPTION OF THE PREFERRED EMBODIMENT

Hereinafter, an apparatus and method for controlling a fan of a refrigerator with a television/radio module according to the present invention will be described in detail with reference to the accompanying drawings.

Herein, “television module” means a device for providing a user with a function of watching television and listening to the radio in the refrigerator with a television/radio module according to the present invention. This television module comprises a television screen, a radio display unit, a speaker, a television power button and a radio power button, which are disposed on a front surface of a refrigerator door.

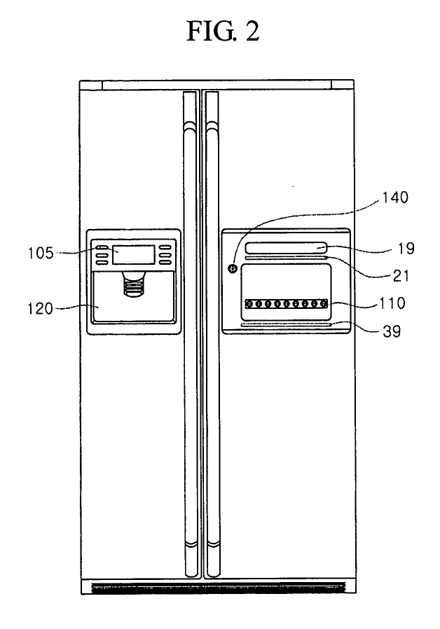

FIG. 2 is a perspective view of a refrigerator including a fan control system according to an embodiment of the present invention. As shown in FIG. 2, the refrigerator 100 of the present invention comprises a main body. Further, a space in which a display unit 105 for indicating the operating functions and temperature state of the refrigerator and a television screen 110 are installed is defined on a front surface of a door of the refrigerator. In addition, the refrigerator includes a dispenser 120 through which ice and water can be dispensed from the refrigerator, a radio display unit 19 on which the radio's frequency and volume are indicated according to the predetermined radio function, a speaker 140 through sound data are output when a user selects a predetermined television and radio function, and the like.

In a preferred embodiment of the present invention, the television screen 110 may be implemented into an LCD screen.

Further, the radio display unit 19 is formed above the television screen 110 on the front surface of the refrigerator door. Thus, the user can confirm at a glance the selected radio's frequency band, volume and the like. In addition, radio function selection buttons 21 for allowing a user to select the radio functions are provided just below the radio display unit 19, and television function selection buttons 39 for allowing a user to select the television functions are provided just below the television screen 110.

According to the refrigerator of the present invention, the refrigerating and freezing units of the refrigerator can be operated according to the temperature conditions. Further, according to the television function selected by the user, the television broadcast can be output to allow the user to watch the television. In addition, the user can listen to the radio broadcast according to the radio function selected by the user.

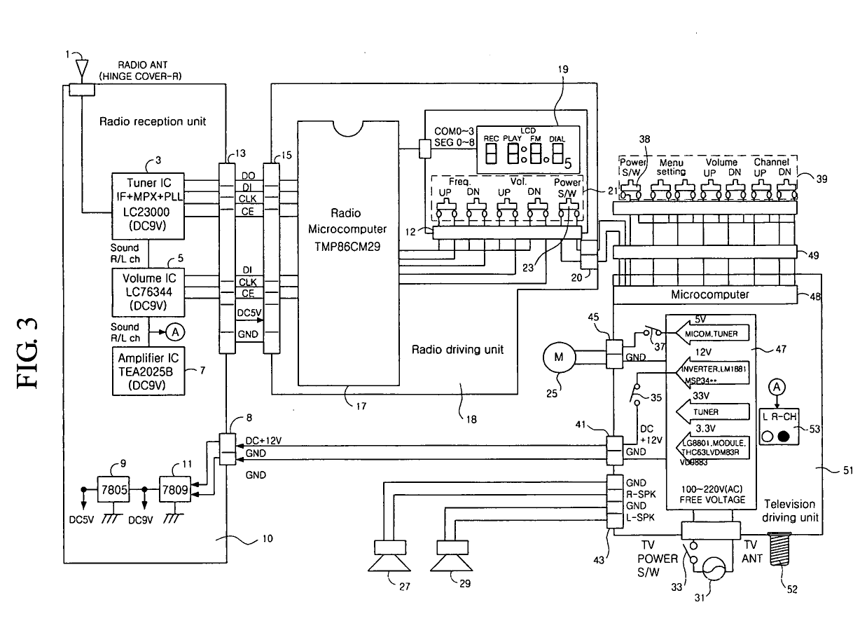

Next, FIG. 3 is a circuit diagram for controlling the functions of a fan in the refrigerator according to the present invention. Herein, the television module comprises a radio reception unit 10, a radio driving unit 18, and a television driving unit 51.

The radio reception unit 10 is composed of a tuner IC 3 for receiving radio signals through an antenna 1, a volume IC 5 for adjusting the volume of the received radio signals, and an amplifier IC 7 for amplifying the received radio signals. Further, the radio reception unit 10 receives a voltage of DC 12 volts from the television driving unit 51 to be explained later through a terminal 8 and also includes elements 9 and 11 for generating a variety of voltages required in the radio reception unit 10. The radio signals that have been processed in the radio reception unit 10 are output to speakers 27 and 29 through left and right channels of the television driving unit 51.

A terminal 13 of the radio reception unit 10 is connected to a terminal 15 of a radio microcomputer 17. The radio microcomputer 17 controls a radio display unit 19 for indicating the operating state of the radio including the radio's frequency, volume and the like, monitors the operating state of the radio function selection buttons 21 for controlling the radio's frequency, volume and electric power through a terminal 12, and performs the controls necessary to the tuner IC 3, volume IC 5 and amplifier IC 7.

A radio power button 23 among the radio function selection buttons is operated when the user selects the radio function, and the operation of the radio power button is transferred to the television driving unit 51 to be explained later through a terminal 20.

Further, through a terminal 49, the television driving unit 51 is connected to the television function selection button 39 for adjusting the menu, volume, channel and power, and the television functions such as channel change or volume control can be adjusted by operating the television function selection buttons 39.

A television power button 38 among the television function selection buttons is operated when the user intends to turn on the television. A variety of television control signals input through the terminal 49 are applied to a microcomputer 48 in the television driving unit 51 to perform the necessary control. The microcomputer 48 controls the reception of television signals from a television antenna 52 and the output of the received television signals to the LCD television screen 110 after the television signals have been processed in the signal processing unit (not shown).

The television driving unit 51 includes a power unit 47 for receiving external power and generating a variety of DC voltages required in operating the television module. A television module power switch 33 for switching an external power source 31 is connected to the power unit 47. The power unit 47 receives electric power from the external power supply 31 and generates a DC power of 5 volts, 12 volts, 33 volts or 3.3 volts.

Further, the television driving unit 51 includes a terminal 43 connected to the speakers 27 and 29, a terminal 41 through which a DC voltage of 12 volts generated in the power unit 47 is output to the radio reception unit 10, and a switch 35 for switching the power to be supplied through the terminal 41.

A heat radiation fan 25 is connected to the television driving unit 51 through a terminal 45 and operated when the television or radio is operated. The operation of the heat radiation fan 25 is controlled by a switch 37. The switch 37 of the heat radiation fan 25, the switch 35 for controlling whether power should be supplied to the radio reception unit 10, and the like are constructed of FET elements. The control of operating the heat radiation fan 25, i.e. the control of switching the switch 37 on or off, is carried out by means of the microcomputer 48.

The heat radiation fan 25 operates to radiate heat generated from a driving circuit for operating the television and radio. Thus, the heat radiation fan 25 is installed on a rear surface of the television screen 110 in which a television/radio driving circuit is installed.

Therefore, the power unit 47 generates a variety of powers required in processing the television and radio signals, and the operation of the power unit 47 and the supply of the power generated in the power unit are controlled by means of the microcomputer 48 in the television driving unit 51. That is, the microcomputer 48 controls the operation of the switches 35 and 37 in order to perform the above control.

Hereinafter, the operation of controlling the television/radio module in the refrigerator according to the present invention so configured will be discussed.

First, an operating process when a user selects the television power button to watch television will be described.

In a state where the television module power switch 33 is turned on and power is applied from the external power source 31 to the television driving unit 51, the user selects the television power button 38. If the television power button 38 is selected, a selection signal is input to the microcomputer 48 through the terminal 49.

The microcomputer 48 recognizes that the user wishes to watch television and performs the control needed in watching television. First, the microcomputer 48 controls the power unit 47 such that a variety of DC voltages needed in watching television can be generated.

Thereafter, the television signals received through the television antenna 52 are processed in the signal processing unit (not shown) and then output to the television screen 110. Further, the sound signals are output through the speakers 27 and 29.

Further, the microcomputer 48 causes the switch 37 to be actuated and controls the supply of power to the heat radiation fan 25 such that the fan 25 can be operated in a state where the television is operated.

Next, an operating process when a user selects the radio power switch to listen to the radio will be described.

In a state where the television module power switch 33 is turned on and power is applied from the external power source 31 to the television driving unit 51, the user selects the radio power button 23. If the radio power button is selected, a selection signal is input to the terminal 49 of the television driving unit 51 and then again to the microcomputer 48.

The microcomputer 48 recognizes that the user wishes to listen to the radio and performs the control needed in listening to the radio. First, the microcomputer performs the necessary control in such a manner that the power unit 47 generates a variety of DC voltages required in listening to the radio and the switch 35 is operated to allow the generated DC voltage to be supplied to the radio reception unit 10.

The voltage of DC 12 volts input to the radio reception unit 10 is converted into a variety of voltages required in various kinds of circuits in the radio reception unit and supplied to the various kinds of circuits. Thereafter, radio signals received through the antenna 1 are processed suitably through the tuner IC 3, volume IC 5 and amplifier IC 7, and then output as sound signals in the left and right channels. The sound signals of the left and right channels are input through a left and right channel signal input unit 53 of the television driving unit 53 and output through the speakers 27 and 29.

In the meantime, when the radio reception unit 10 is operated, frequency and volume signals that a user adjusts by means of the radio function buttons 21 are input to the radio microcomputer 17 by which the frequency, volume and the like of the radio signals can be controlled by means of the tuner IC 3, volume IC 5 and amplifier IC 7.

Further, the microcomputer 48 causes the switch 37 to be actuated and controls the supply of power to the heat radiation fan 25 such that the fan 25 can be operated in a state where the radio is operated.

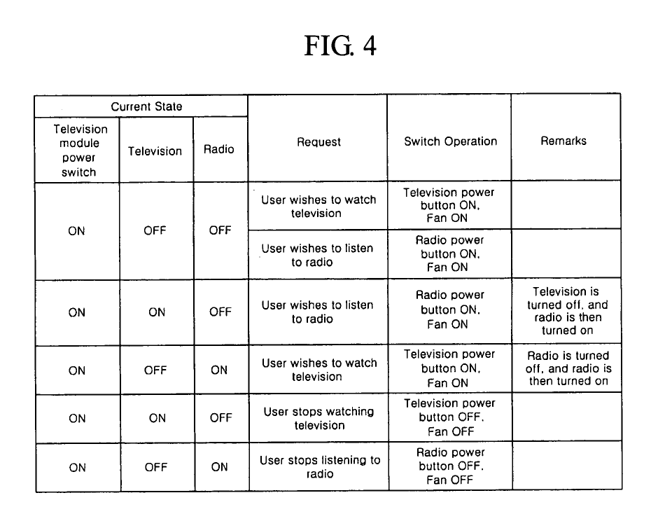

FIG. 4 is a table illustrating a state where the television/radio module of the refrigerator is currently controlled and a state where the switches are operated according to the request of a user.

In a state where both television and radio functions are turned off, a user can select the television function if he/she wishes to watch television. The operation of selecting the television function is made by converting the television power button 38 into an ON state. This selection operation causes the television driving unit 51 to be operated. As a result, video and sound data of the television broadcast are output.

Further, in a state where both television and radio functions are turned off, a user can select the radio function if he/she wishes to listen to the radio. The operation of selecting the radio function is made by converting the radio power button 23 into an ON state. This selection operation causes the radio reception unit 10 and the driving unit 18 to be operated, and thus, the user can listen to the sound data in a desired frequency band by adjusting the desired radio's frequency. At this time, the television driving unit 51 supplies the radio reception unit 10 and radio driving unit 18 with desired electric power.

Furthermore, in a state where the television function is turned on and the radio function is turned off, a user can select the radio function if he/she wishes to listen to the radio. The selection of the radio function is made by converting the radio power button 23 into an ON state. At this time, the microcomputer 48 of the television driving unit 51 recognizes an operating state of the radio power button 23 and terminates the television operation. That is, this operation indicates that the microcomputer 48 terminates the television function and converts a current function into the radio function when the radio power button 23 is again selected in a state where the television power button 38 has been already selected.

On the other hand, in a state where the television function is turned off and the radio function is turned on, a user can select the television function if he/she wishes to watch television. The selection of the television function is made by converting the television power button 38 into an ON state. At this time, the microcomputer 48 of the television driving unit 51 recognizes an operating state of the television power button 38 and terminates the currently running radio operation. That is, this operation indicates that the microcomputer 48 terminates the radio function and converts a current function into the television function when the television power button 38 is again selected in a state where the radio power button 23 has been already selected.

In addition, in a case where a user wishes to terminate a current operating state when the television or radio is operating, the process will be controlled as follows. That is, the television power button 38 is controlled to be turned off when the television is operating, whereas the radio power button 23 is controlled to be turned off when the radio is operating. At this time, the control switch 37 is also controlled to be switched off.

As described above, the present invention is configured in such a manner that the microcomputer 48 controls the operations of the television and radio according to the operating state of the power button that has been most recently selected by the user. In addition, the above operations are controlled in a state where the television module power switch 33 is turned on.

Further, when the television driving unit 51 and the radio driving unit 18 are operated such that a user can watch television or listen to the radio, the microcomputer 48 operates the heat radiation fan 25 such that heat generated due to the operation of the driving units can be radiated.

However, in a state where the television or radio function is not performed while the television module power switch 33 is kept turned on, the heat radiation fan 25 is not operated.

Next, the operation of controlling a fan in accordance with the operation of the television/radio module installed in the refrigerator of the present invention will be described.

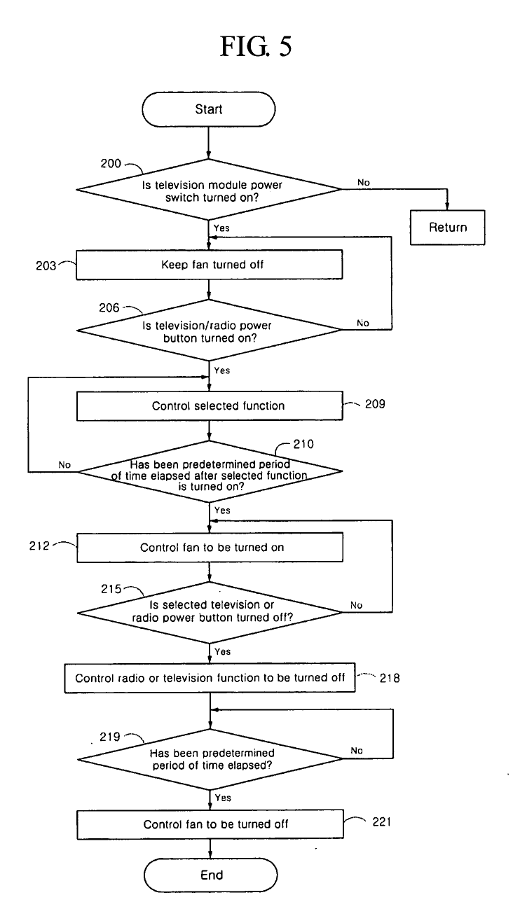

FIG. 5 is a flowchart illustrating a fan control operation performed in accordance with the operation of the television/radio module installed in the refrigerator of the present invention.

First, a user turns on the television module power switch 33 when he/she wishes to utilize the television/radio module attached to the refrigerator (step 200). At this time, the fan 25 is kept turned off (step 203).

However, if the user selects the television or radio function, the fan will also be operated accordingly. The user can select the television power button 38 when he/she wishes to watch television, whereas the user can select the radio power button 23 when he/she wishes to listen to the radio (step 206). Therefore, step 203 is maintained until the condition in step 206 is satisfied. However, if any one of power buttons is selected in step 206, the microcomputer recognizes which power button was selected and controls operating the selected function. The microcomputer controls the radio function when the radio power button has been selected, whereas the microcomputer controls the television function when the television power button has been selected (step 209).

The microcomputer also determines whether a predetermined period of time (approximately, 1 to 2 seconds) has been elapsed after the control of the selected function has been performed in step 209 (step 210). Step 210 is required for the following reasons. That is, since an instantaneous current is likely to be excessively high if both the fan and television/radio module are simultaneously operated, they can be sequentially operated to reduce a peak value of the instantaneous current.

After the predetermined period of time has been elapsed, the fan switch is turned on to control the fan to be turned on. According to this operation, a predetermined voltage generated in the power unit is supplied to the fan through the switch, and thus, the fan will be operated (step 212). The fan radiates heat generated in the driving circuit due to the operation of the television or radio.

Further, the microcomputer maintains the current operating control state until the television or radio power button that was selected in step 206 is controlled to be turned off (step 215). If the television or radio power button is turned off, the television or radio function is also controlled to be turned off (step 218).

The microcomputer also turns off the fan switch when a predetermined period of time (approximately, 1 to 2 seconds) has been elapsed after the operating television or radio power button is turned off in step 218, so that the fan cannot further be unnecessarily operated in response to the operation of turning off the television or radio.

As described above, the method for controlling a fan of a refrigerator with a television/radio module according to the present invention is characterized in that when the television or radio is operated, electric power is controlled to be automatically supplied to the heat radiation fan such that heat generated due to the television or radio operation can be radiated. Further, the heat radiation fan is also controlled to be automatically turned off when the television and radio operation is terminated. Therefore, the unnecessary operation of the heat radiation fan is prevented, and consequently, reduction in electric power consumption and efficient control can be made.

According to the present invention, the heat radiation fan can be controlled to be turned off according to the operation of turning off the television or radio. Therefore, there is an advantage in that unnecessary fan operation can be avoided and electric power consumption can also be reduced.

Further, there is another advantage in that deterioration in the image quality of the television attached to the refrigerator due to noise which may be generated when heat generated from the television driving unit cannot be effectively radiated can be prevented.

It will be apparent to those skilled in the art that various modifications and changes can be made thereto without departing from the scope of the present invention. Therefore, the true scope of the present invention should not be limited to the embodiment described and illustrated above but defined by the appended claims.

What is claimed is:

1. A method for controlling a fan of a refrigerator with a television/radio module, comprising:
a monitoring step of monitoring an operation of a television power button for selecting a television function and an operation of a radio power button for selecting a radio function in a state where electric power is supplied to the television/radio module; and
a fan control step of controlling the fan in such a manner that electric power is supplied to a heat radiation fan for radiating heat generated due to the television/radio operation when any power button is turned on in the monitoring step, whereas the electric power supplied to the fan is cut off when the operating power button is turned off.

2. The method as claimed in claim 1, wherein in the fan control step, the supply of electric power to the heat radiation fan is made when a predetermined period of time has been elapsed after the television or radio power button is turned on.

3. The method as claimed in claim 1, wherein in the fan control step, the supply of electric power to the heat radiation fan is cut off when a predetermined period of time has been elapsed after the television or radio power button is turned off.

4. An apparatus for controlling a fan of a refrigerator with a television/radio module, comprising:
a television power button for selecting a television function;
a radio power button for selecting a radio function;
a television module power switch for enabling electric power to be supplied to the television/radio module;
a heat radiation fan installed at a rear surface of a television panel for radiating heat generated due to a television and radio operation;
a fan control switch for switching on or off electric power supplied to the heat radiation fan; and
a microcomputer for monitoring an operating state of the television and radio power buttons and controlling the fan control switch in such a manner that the fan control switch is turned on when the television or radio power button is turned on, whereas the fan control switch is turned off when the operating power button is turned off, in a state where the television module power switch is turned on.

5. An apparatus for controlling a fan of a refrigerator with a television/radio module including television and radio power buttons and a heat radiation fan for radiating heat generated due to a television and radio operation, said apparatus comprising:
a fan control switch for switching on or off electric power supplied to the heat radiation fan; and
a microcomputer for monitoring an operating state of the television and radio power buttons in a state where a television/radio module power switch is turned on, and controlling the fan control switch in such a manner that the fan control switch is turned on when the television or radio power button is turned on, whereas the fan control switch is turned off when the operating power button is turned off.

6. The apparatus as claimed in claim 5, wherein the microcomputer controls supplying the heat radiation fan with electric power when a predetermined period of time has been elapsed after the television or radio power button is turned on.
